(19) United States
(12) Patent Application Publication
(10) Pub. No.: US 2008/0244867 A1
(43) Pub. Date: Oct. 9, 2008

(54) HINGE COVERING SYSTEM

(76) Inventor: James TUELL, Smithsburg, MD (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/060,624

(22) Filed: Apr. 1, 2008

Related U.S. Application Data
(60) Provisional application No. 60/909,740, filed on Apr. 3, 2007.

(51) Int. Cl. E05D 11/00

(52) U.S. Cl. 16/250

(57) ABSTRACT

A hinge covering system designed to protect an operable door hinge from paint spray, paint splatters, or any other coating that may be applied to the surface of a door and/or frame. The hinge covering system comprises a plurality of preformed tape pieces. The tape pieces having been preformed to match areas of the door hinge so as to prevent excessive overlap covering the door or frame, yet adequately protect the door hinge. Each of the preformed tape pieces are designed to adhere to and thereby protect different areas of the door hinge. Specifically, the hinge covering system is comprised of tape pieces pre-measured to fit the exposed areas of the hinge straps, the hinge barrel, and the top and bottom of the hinge pin. At least one of the tape pieces is formed so as to protect the barrel portion of the door hinge without causing friction or adhesion to the barrel portion thus allowing for un-obscured operation of the door with the hinge covering system fully installed. The hinge covering system prior to installation on a hinge is stored as a roll of tape. Each preformed tape piece is stored in the tape roll with a perforation or equivalent means to remove each preformed tape piece from the roll to the preformed tape piece's exact measurement, thereby allowing efficient use with minimal waste product.

### BACKGROUND OF THE INVENTION

### Field of the Invention

The present invention relates to a means for covering a door hinge so as to protect the hinge from paint or coating while the door and/or frame of the door are being painted and/or coated. More particularly the present invention provides a hinge covering system which allows for rapid and efficient installation of the system which accurately protects the door hinge while also maintaining un-obstructed use of the hinge, and thereby the door.

In the field of painting building interiors, interior doors and their frames must be painted as well as the interior walls and ceiling. When painting the door and door frame area, a common problem arises that paint or coating will adhere to door hinges supporting the door to the interior walls. Since the standard door hinges are metal with a polished finish, paint adhered to the hinges generally has a non-aesthetic appearance and is therefore not desired when painting the building interior. As such, the hinges of the doors must be protected from paint and coating during the painting of the building interior.

The standard door hinge used in most modern homes and offices is comprised of three portions: a left strap, a right strap and a pin. Three screws are used to secure one strap to a frame, and three additional screws secure the remaining strap to the door. Each strap has either a two open cylindrical portion or a three open cylindrical portion, referred to as knuckles, which are designed to interpose one another and receive the pin into the opening for securing the door to the frame and maintaining normal operation of the door. When the hinge is in an operable state, the knuckles and pin exposed between the door and the frame are referred to as the barrel.

There are a variety of door hinge sizes available to the building industry. They all vary in length and width depending on the size and weight of the door they are intended to support.

The most commonly used in residential housing is called a “butt hinge”. Each strap measures approximately 3½″ in length and 1½″ in width, with the cylindrical portion measuring approximately 7/16″. Totaling the overall width to approximately 3½″. This is a “full mortise hinge”. The thickness of the hinge strap, which is approximately 1/16″ is recessed into the door and frame. Different styles are available; the first style has two ⅝″ radius cuts on one edge of each strap, the second style has two ¼″ radius cuts on one edge of each strap, a third style has squared corners on each strap, and the fourth style consists of one strap having a radius cut and the other strap squared. The cylindrical protrusions that extend from each strap also vary in size, depending on the hinge size. Standard pre-made Residential Hinges are readily available in the following dimensions:
3″ by 3″ with ⅝″ radius corners
3½″ by 3½″ with ⅝″ radius corners
4″ by 4″ with ⅝″ radius corners
3½″ by 3½″ with ¼″ radius corners
4″ by 4″ with ¼″ radius corners
3½″ by 3½″ with square corners/⅝″ radius corners
4″ by 4″ with square corners/⅝″ radius corners.

In commercial building the most commonly used hinges are “architectural hinges” which range from 3½″ to 6″ in length and 3″ to 6″ in width, these normally have a larger cylinder (these hinges may also have the same radius cut on each strap, or each strap could be different as with the “butt hinge”). Another style of commercial hinge is an “architectural ball bearing hinge”. This type of hinge is used for large or very heavy doors. These hinges are similar to the “butt hinge” and the “architectural hinge” with the exception of a ball bearing device which is machined into the knuckles, allowing the hinge to carry more weight without wearing out or breaking. Standard pre-made Commercial Architectural Hinges are readily available in the following dimensions:
3″×3″ with square corners
3½″ by 3½″ with square corners or square/⅝″ radius
4″ by 4″ with square corners or square/⅝″ radius
4½″ by 4½″ with square corners or square/⅝″ radius

Standard pre-made Architectural Ball Bearing Hinges (heavy duty) are readily available in the following dimensions:
4″ by 4″ with square corners or square/⅝″ radius
4½″ by 4½″ with square corners or square/⅝″ radius
5″ by 5″ with square corners or square/⅝″ radius

Several options are available for protecting the hinges during painting. The two most common options are that the doors may be removed so that the hinges are not present during painting, or the hinge may be covered with tape or similar adhesive which absorb any paint applied to the area of the door hinge and thereby protects the hinge. However, there are a number of drawbacks to utilizing either of these methods to protect the hinge.

First, removing the doors and hinges prior to painting, and re-installing the doors after painting, is time consuming. Specifically, each hinge is normally held to the door and the frame by six screws, each of which must be individually removed and re-installed. Alternatively, if only the pin is removed from the cylinder portion to separate the door from the frame, each strap would have to be taped separately and the doors could still only receive one coating on one side at a time. Further, the doors must be stored during the painting process. If the doors are to be painted and they were removed from the hinge, this method would allow only one side at a time to receive the coating intended. After drying, the doors would be reversed and the other side coated. These extra steps create a need for additional labor and therefore add further time consumption to the painting process.

Second, covering the door hinges is either also time consuming or is inadequate to properly protect the hinges. The portions of the hinge exposed during the painting process must be protected in a manner which adequately covers the hinge but also does not disrupt the painting or coating of the door and frame. In order to properly shape common painting tapes to cover the hinge requires additional time, as the pieces of tape must be cut and sized at the job site. Hence, properly forming the tape at the job site also requires additional labor and thereby further adds time consumption to the painting process. Alternatively, the protective tape is applied in a rapid manner without regard to exactly matching the area of the exposed hinge. This taping procedure results in poor protection which in turn results in either paint adhered to the hinge or lack of adequate paint coverage to the door and/or frame. Hence, the aesthetic value of the painting is decreased.

An additional problem which results from covering the hinges with a protective adhesive is that operation of the door becomes difficult due to adhesive being in contact with the moving portions of the door hinge. Specifically, the standard door hinge includes a barrel portion which is exposed between the door and the frame. This barrel portion is rotated within itself when the door is opened and closed. Adhesive of a protective coating is likely to either, interfere with the operation of the door, and/or pull or disfigure the protective tape, thereby disrupting the protective tape's coverage of the hinge. In some instances, the protective tape may even be pulled off by repeated opening and closing of the door leaving the hinge exposed during painting.

In response to these problems of protecting door hinges during painting, a number of solutions have been presented. However, each of these solutions fails to adequately and efficiently cover the door hinge, and also maintain un-obscured operation of the door. Specifically, preconfigured tape or masks for paint protection of hinges have been disclosed in U.S. Pat. Nos. 3,961,602; 4,195,590; 4,691,409; 4,796,330; 5,056,191; and 5,882,788.

The '602, '590 and '330 patents each disclose masks which are flexible members that have a pressure treated, sensitive adhesive coating and are pre-shaped to be applied over the hinge. However, the '602 and '590 masks are useable only with the doors that have been removed from the hinges, or separated from the door frame. Hence, the design of the '602 and '590 prevents them from being installed or applied to a door that is in an operable position. Further, the masks offer no coverage to the top and bottom of the pin and barrel portions of the hinge.

The '330 device maybe applied to a door in an operable position. The '330 device consists of two monolithic parts. One of which is configured to provide full coverage of the front faces of the leaves and barrel of the assembled hinge. The other being configured to cover the exposed parts of the back faces of the leaves and barrel. However, this system includes adhesive applied to the rotating barrel portion of the hinge. Thus, the '330 device will interfere with the operation of the door and/or be removed by the opening and closing of the door based on the adherence of the mask system to the moving barrel portion.

U.S. Pat. No. 5,056,191 discloses a system comprising a pad with a protective coating that is peeled off from a cut out and applied to the hinge. U.S. Pat. No. 5,882,788 is very similar to the '191 patent in that they both have small rectangular protrusions that extend from the main body of the adhesive. These are intended to cover the knuckle portions of the hinge; one side having two protrusions, and the other side having three protrusions. As these protrusions have adhesive to secure the protective coating to the knuckle, they will interfere with the operation of the door and/or be removed by the opening and closing of the door based on the adherence of the mask system to the moving barrel portion.

The '788 and '191 also suffer from the defect that it is difficult to align all of these protrusions and the corners of the main body of the plate at the same time. The piece with three protrusions has to be used on the appropriate hinge plate and the one with the two protrusions has to be used on the remaining hinge plate. Further, throughout an entire house there are left hand swing doors which open to the left, and right hand swing doors which open to the right. Thus, the systems of the '788 and '191 patent would be confusing to use due to difficulty ensuring that the right piece of hinge cover is applied to the correct side of the hinge plate. Also, all doors in a house or office do not always open to the hinges fullest capability, due to a wall or another object of some sort restricting the movement. Therefore, the small protrusions that extend from the body of the hinge plate cover would have to either be trimmed back or tucked into the very thin space between the rotating pieces. If this is not done, the protrusions would overlap onto the opposite hinge cover and could then break loose, due to the movement of the rotating pieces. The portion of the hinge barrel that is seen when the door is completely closed is covered in the same manner (having to align the protrusions with the rotating portions).

Additional tape hinge systems have been proposed which utilize protective magnetic or plastic coverings over the door hinges. However, there has not been disclosed to date, a hinge tape system which is able to efficiently and accurately cover a door hinge in a manner which does not interfere with the door's operation and/or prevent the covering from being damaged, disjointed or removed by operation of the door.

### SUMMARY OF THE INVENTION

The current invention provides a hinge tape system which is efficiently applied by utilizing a system of a plurality of tape pieces that are pre-formed to protect the distinct portions of the hinge straps, the rotating portions of the hinge barrel in a non-adhered manner, and the top and bottom of the hinge pin when painting doors and frames. The current invention may be more efficiently used based on the pre-formed pieces being rolled in a tape style manner and perforated between the individual pieces. Further, the current hinge tape system includes a pre-formed piece which excludes adhesive from contacting the moving portions of the hinge barrel, thereby allowing continued un-obscured use of the door while maintaining full protection from paints and coating by the tape system.

### BRIEF DESCRIPTION OF THE DRAWINGS

FIG. 1 illustrates a first performed tape piece according to a preferred embodiment of the present invention.

FIG. 1a illustrates a door hinge having the top and bottom portions of the pin portion of the door hinge protected by first preformed tape pieces according to a preferred embodiment of the present invention.

FIG. 1b illustrates a double door slide lock having entire surface protected by first preformed tape pieces according to a preferred embodiment of the present invention.

FIG. 1c illustrates the first preformed tape pieces according to a preferred embodiment of the present invention stored in a pre-use form as a roll.

FIG. 2 illustrates a back (second) surface of a second preformed tape piece according to a preferred embodiment of the present invention.

FIG. 2a illustrates a front (first) surface of a second preformed tape piece according to a preferred embodiment of the present invention.

FIG. 2b illustrates a door hinge as set forth in FIG. 1a further having the inner barrel portion of the door hinge protected by a second preformed tape piece according to a preferred embodiment of the present invention.

FIG. 2c illustrates an outer barrel portion of a door hinge protected by a second pre-formed tape piece according to a preferred embodiment of the present invention.

FIG. 2d illustrates the second preformed tape pieces according to a preferred embodiment of the present invention stored in a pre-use form as a roll.

FIG. 3 illustrates a third preformed tape piece according to a preferred embodiment of the present invention.

FIG. 3a illustrates a door hinge as set forth in FIG. 2a further having the right and left strap portions of the door hinge protected by third preformed tape pieces according to a preferred embodiment of the present invention.

FIG. 3b illustrates the first preformed tape pieces according to a preferred embodiment of the present invention stored in a pre-use form as a roll.

### DETAILED DESCRIPTION OF THE INVENTION

The preferred embodiment of the present invention comprises about three separate rolls of masking, with each roll comprising precut and perforated tape pieces to match distinct portions of the door hinge as needed to ensure adequate protection. The hinge tape system of the preferred embodiment provides preformed tape pieces to distinctly protect the hinge straps, the rotating portions of the barrel, and the hinge pins while maintaining full operability of the door and protection of the hinge.

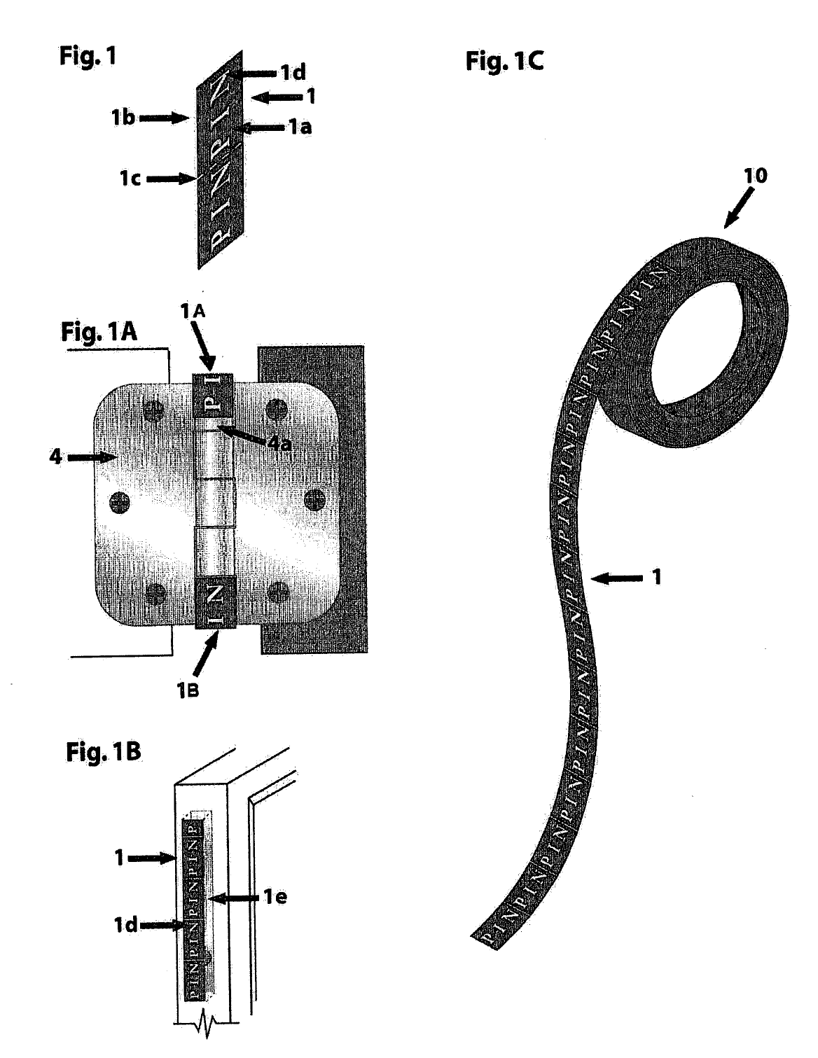

The first preformed tape piece comprises a masking having an adhesive on one side thereof. The first preformed tape piece is stored in a standard roll with perforations sized to match the area of the top and bottom exposed portions of the hinge pin. For example, for a standard residential door hinge, the first preformed tape piece is stored in a standard roll of about ¾″ with perforations about every 1½″. FIG. 1 illustrates the first preformed tape piece 1. The first preformed tape piece 1 comprises a first surface 1a which is free of adhesive. The first surface 1a faces outward from the hinge pin to provide protection from painting and coating. The second surface 1b faces inward for contact with the top and the bottom of the hinge pin and storage as a tape roll. The first surface 1a may also be provided with a mark along every perforation 1c. The first surface 1a may also be provided with the word PIN 1d stamped on the surface to assist the user in proper application of the tape system.

FIG. 1a illustrates a hinge 4 wherein two separate pieces 1A/1B of the first preformed tape piece are applied to the exposed portion of the center of the hinge 4a. A first piece 1A is applied to the top of the center of the hinge 4a, so as to cover and thereby protect the upper most knuckle of the hinge and the top of the hinge pin. A second piece of the first preformed tape piece 1B is applied to the bottom of the center of the hinge 4a, so as to cover and thereby protect the lower most knuckle of the hinge and the bottom of the hinge pin.

Also, as an aside, FIG. 1b illustrates a plurality of first preformed tape pieces 1, sized for use with a standard residential hinge, used to protect the slide lock 1e on the edge of a double door which are ¾″ wide and approximately 6″ long by removing about four of the first preformed tape pieces from the roll, and maintaining the perforation 1d between the pieces to completely cover the slide lock 1e.

FIG. 1c illustrates the first preformed tape pieces 1 stored prior to use as a roll 10. The first preformed tape pieces are adhered front surface to back surface as a standard roll of tape. Thus additional sheets for laminating the tape pieces to maintain the adhesive during prior use storage are not required thereby allowing efficient use with minimal waste product.

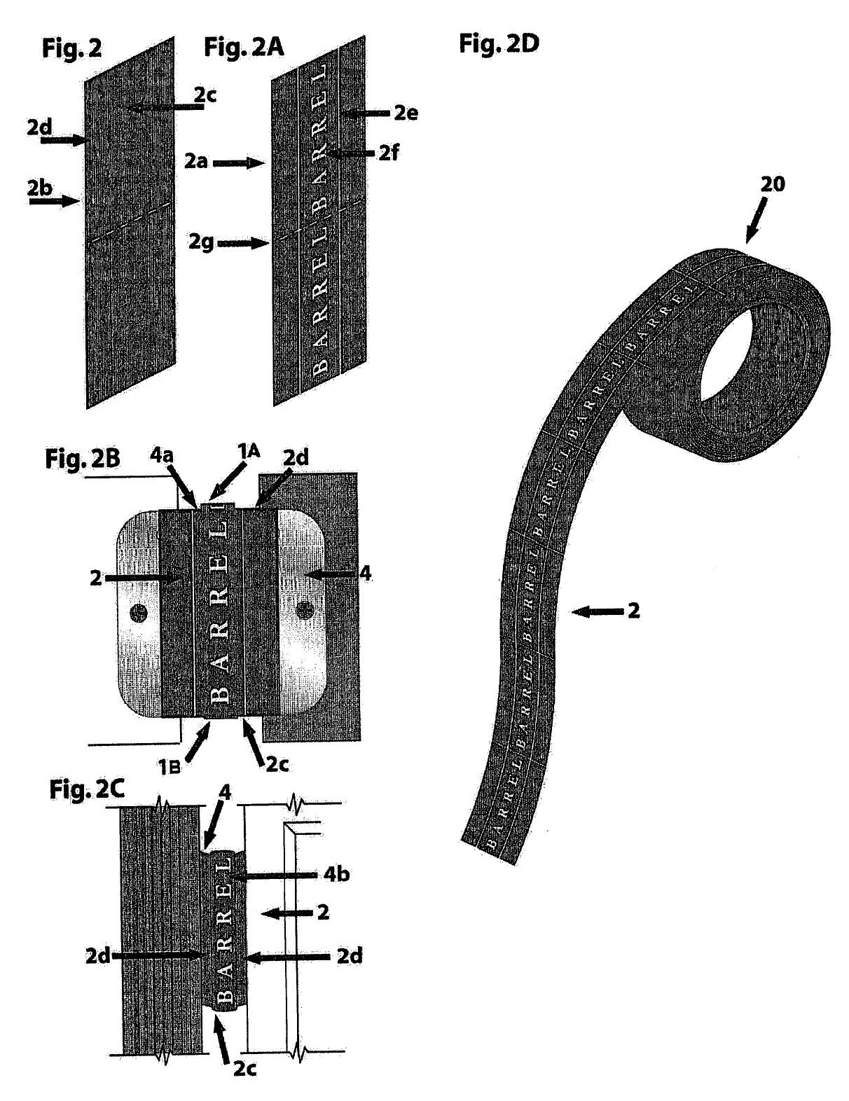

The second preformed tape piece comprises a masking having an adhesive on only a part of one surface. For example, for a standard residential door hinge, the second preformed tape piece comprises a 2″ by 3½″ masking having an adhesive on only a part of one surface. As illustrated in FIG. 2, the second preformed tape piece 2 comprises a first surface 2a which is free of adhesive. The first surface 2a faces outward from the hinge to provide protection from painting and coating. The second surface 2b faces inward for contact with the hinge and storage as a tape roll. The second surface 2b has a “deadened” center 2c about ⅞″ wide which extends the full length of the second preformed tape piece 2. This deadened center 2c is free of adhesive whereas the remainder of the second surface 2b has adhesive applied thereto forming adhesive areas 2d.

As illustrated in FIG. 2a, in order to assist the user in application of the second preformed tape piece 2 to the hinge 4, the first surface 2a maybe provided with a marking 2e to indicate the location of the deadened center 2c in relation to the adhesive areas 2d on the second surface 2b. The first surface 2a may also be provided with the word BARREL 2f stamped along the center between markings 2e to assist the user in proper application. The first surface 2a may also be provided with a mark 2g along the perforation to insure accuracy in tearing.

FIG. 2b illustrates the second preformed tape piece 2 as applied in the hinge tape system of the preferred embodiment to the interior center hinge portion 4a. The second preformed tape piece 2 overlays the hinge 4 so as to completely cover the interior center hinge portion 4a with the deadened center 2c of the second preformed tape piece 2. The second preformed tape piece 2 overlays end portions of the first preformed tape pieces 1A/1B. The adhesive areas 2d are applied to the inner portion of the hinge straps thereby securing the second preformed tape piece 2 to the hinge 4. Since the deadened center 2c of the second preformed tape piece 2 is free of adhesive, the tape piece 2 will not interfere with the rotating motion of the knuckles and pin of the hinge 4 when the door is in operation. Hence, the door will maintain un-obscured operation while the interior center hinge portion 4a is protected without adhesive pulling the tape piece 2 loose or disrupting the coverage by the tape piece 2 by contacting the knuckles or pin.

FIG. 2c illustrates the second preformed tape piece 2 as applied in the hinge tape system of the preferred embodiment to the exterior center hinge portion 4b. The second preformed tape piece 2 is applied over the exterior center hinge portion 4b on the opposite side of the door and frame as to the interior center hinge portion 4a. Similar to above, the deadened center 2c of the second preformed tape piece 2 is applied to the knuckle and pin portion comprising the exterior center hinge portion 4b so as to prevent adhesive from contacting these rotating portions of the door hinge 4. The adhesive areas 2d are applied to exterior exposed areas of the strap portion of the door hinge. These adhesive areas 2d are preferably tucked into the space between the door and the straps by any common means, such as a 5-in-1 tool or putty knife. Thereby, the exterior center hinge portion 4b is protected from paint and coating while maintaining un-obscured operation of the door and insuring that the second preformed tape piece 2 will remain in place even with repeated use of the door.

FIG. 2d illustrates the second preformed tape piece 2 stored prior to use as a roll 20. The second preformed tape pieces are adhered front surface to back surface as a standard roll of tape. Thus additional sheets for laminating the tape pieces to maintain the adhesive during prior use storage are not required thereby allowing efficient use with minimal waste product.

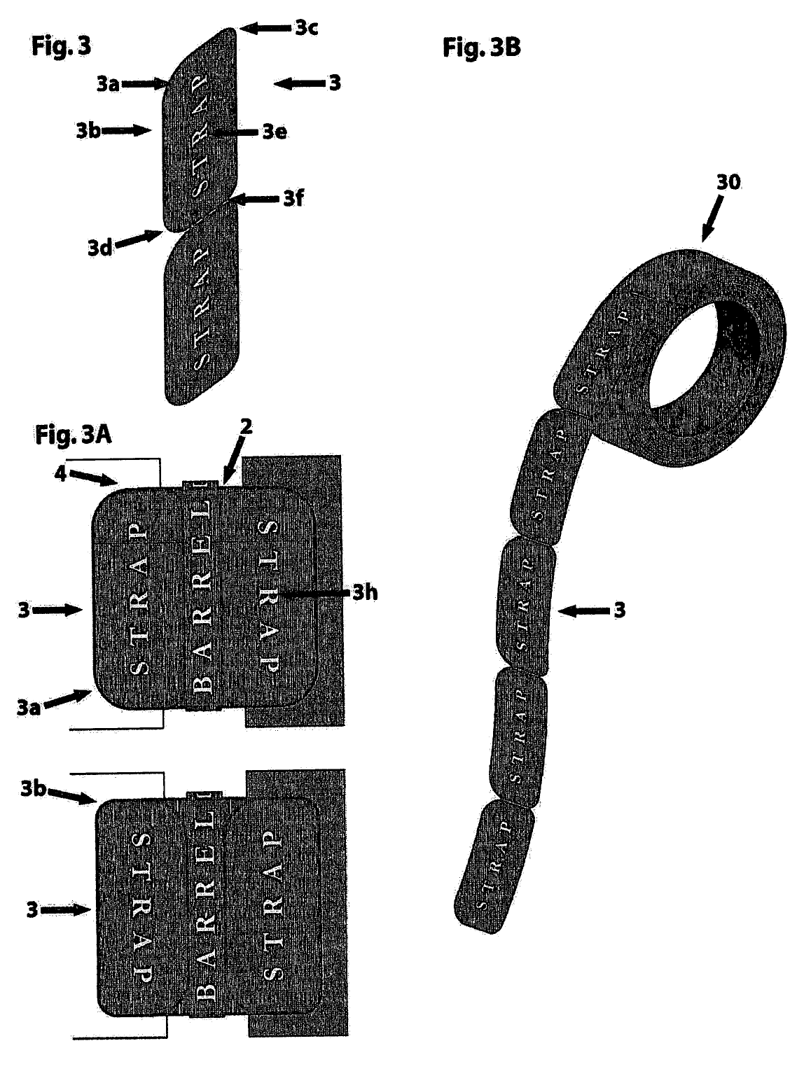

FIG. 3 illustrates a third preformed tape piece 3 comprising a first surface 3a which is free of adhesive. The first surface 3a faces outward from the hinge to provide protection from painting and coating. The second surface 3b faces inward for contact with the hinge strap and storage as a tape roll. The third preformed tape piece 3 also consists of having preformed corners 3c/3d on opposite sides thereof to correspond to the exact shape of the door hinge strap to be covered. For example, a third preformed tape piece 3 for a standard residential hinge strap would have both ¼″ 3c and ⅝″ 3d rounded corners. The outer surface 3a may also be provided with the word STRAP 3e stamped on the surface to assist the user in proper application of the tape system. The surface 3a also provides a mark 3f along each perforation.

FIG. 3a illustrates the third preformed tape piece 3 as applied in the hinge tape system of the preferred embodiment. For example, for a standard residential door hinge, the third preformed tape piece is about 1½″ by 3½″ with a side thereof having adhesive to be placed on the outer strap portion of the exposed hinge 4. The third preformed tape piece 3 is applied to cover the interior exposed hinge strap portions and partially overlay the second preformed tape piece 2. This third tape piece 3 preferably has corresponding corners 3a/3b on one side thereof to conforming to the exact shape of the door hinge strap to be protected. The outer surface of piece 3 may also be provided with the word STRAP 3h stamped on the surface to assist the user in proper application of the tape system.

The corners of the third preformed tape piece may be formed to match any two door hinge strap corners. Most preferable, the third preformed tape piece 3 is precut to fit either a door hinge strap with a radius of ¼″ or ⅝″. The majority of residential pre-hung door hinges have a ⅝″ radius cut, or less common, a ¼″ radius cut. In order to accommodate either of these hinge sizes, the third preformed tape piece is shaped so that one side of the masking has a ¼″ radius cut on the upper right corner and the same cut on the lower right corner. A ⅝″ radius cut is on the upper left corner and has the same cut on the lower left corner. Therefore, enabling not only this roll, but the entire kit to be used on two different radius hinges by simply rotating the third preformed tape piece to have the exterior corners match the exterior corners of the hinge strap. Still further, a square cut corner can be combined with either of the two rounded corners to correspond to a square cut hinge strap.

As illustrated in FIG. 3b, illustrates the third preformed tape piece 3 stored prior to use as a roll 30. The third preformed tape pieces are adhered front surface to back surface as a standard roll of tape. Thus additional sheets for laminating the tape pieces to maintain the adhesive during prior use storage are not required thereby allowing efficient use with minimal waste product.

As set forth above, the hinge tape system of the preferred embodiment utilizes a total of six preformed tape pieces, two each of the first, second and third preformed tape pieces, to cover a single door hinge. With the hinge tape system, the door maybe opened to the full limit of the hinge, or to a lesser degree, and the tape system will maintain full protection of the hinge. The pieces described above are designed so that each covers a particular portion of the surface of the hinge despite the position of the hinge. When the hinge plate, the hinge pin (upper and lower portion), and the barrel are covered using this system, there is no area of the door or frame that is restricted from an intended coating. Nor, is the hinge subject to paint overspray or paint splatters.

The hinge tape system is not limited to three preformed tape pieces but may include other tape pieces or configurations which cover the exposed portions of a door hinge. For example, a fourth optional roll may also be included comprising a ¼″ tape to be used to protect the very top portion of the hinge straps that protrude from the recessed portion of the door and the door frame. However, as this area of the hinge is most commonly not visible, there is often no loss of aesthetic value by painting or coating this area.

Further, the hinge tape system may be comprised of preformed tape pieces which match commercial hinges or other specially designed hinges.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A hinge tape system, comprising:
a first tape roll having a plurality of first tape pieces, wherein each of said first tape pieces is sized to match about an area of top and bottom portions of a door hinge pin;
a second tape roll having a plurality of second tape pieces, wherein each of said second tape pieces is sized to cover an entire area of a door hinge barrel and a portion of an area of door hinge straps; each of said second tape pieces having an adhesive free portion on a first surface and an adhesive portion on said first surface;
a third tape roll having a plurality of third tape pieces, wherein each of said third tape pieces is sized to match about an entire area of a single door hinge strap.

2. The hinge tape system according to claim 1, wherein each of said first tape pieces is about ¾″ by 1½″ in area.

3. The hinge tape system according to claim 1, wherein each of said second tape pieces is about 2″ by 3½″ in area.

4. The hinge tape system according to claim 1, wherein each of said third tape pieces is about 1½″ by 3½″ in area.

5. The hinge tape system according to claim 1, wherein each of said third tape pieces further comprises rounded corners.

6. The hinge tape system according to claim 5, wherein at least two of said rounded corners have a radius of one of the group consisting of square, ⅝″ radius and ¼″ radius.

7. The hinge tape system according to claim 5, wherein two of said rounded corners are ⅝″ radius and another two of said rounded corners are ¼″ radius.

8. The hinge tape system according to claim 1, wherein said adhesive free portion on said first surface of each of the second tape pieces is about ⅞″ wide extending a full length of the second tape piece and is located at a center portion of the first surface of the second tape piece.

9. The hinge tape system according to claim 1, wherein an adhesive surface of each of said plurality of first tape pieces directly adheres to a non-adhesive surface of another of said first tape pieces within said first tape roll;
wherein the adhesive portion on the first surface of each of said plurality of said second tape pieces directly adheres to a second surface of another of said second tape pieces within said second tape roll; and,
wherein an adhesive surface of each of said plurality of third tape pieces directly adheres to a non-adhesive surface of another of said third tape pieces within said third tape roll.

10. The hinge tape system according to claim 1, wherein connection points between each of said plurality of first tape pieces within said first tape roll are perforated;
wherein connection points between each of said plurality of second tape pieces within said second tape roll are perforated;
wherein connection points between each of said plurality of third tape pieces within said third tape roll are perforated.

11. A hinge tape system, comprising:
a first tape roll having a plurality of first tape pieces, wherein each of said first tape pieces comprises means for covering a portion of a door hinge pin of a door hinge so as to protect said portion of said door hinge pin from painting or coating;
a second tape roll having a plurality of second tape pieces, wherein each of said second tape pieces comprises means for covering a barrel portion of said door hinge so as to protect said barrel portion from painting or coating wherein said barrel portion is not adhered by an adhesive portion of said second tape piece;
a third tape roll having a plurality of third tape pieces, wherein each of said third tape pieces comprises means for covering a strap portion of said door hinge so as to protect said strap portion from painting and coating.

12. The hinge tape system according to claim 11, wherein the proportion of said door hinge protected by said first, second and third tape pieces is one of the group consisting of: 3″ by 3″ with ⅝″ radius corners; 3½″ by 3½″ with ⅝″ radius corners; 4″ by 4″ with ⅝″ radius corners; 3½″ by 3½″ with ¼″ radius corners; 4″ by 4″ with ¼″ radius corners; 3½″ by 3½″ with square corners/ ⅝″ radius corners; 4″ by 4″ with square corners/⅝″ radius corners; 3″×3″ with square corners; 3½″ by 3½″ with square corners or square/⅝″ radius; 4″ by 4″ with square corners or square/ ⅝″ radius; and, 4½″ by 4½″ with square corners or square/⅝″ radius.
